(19) United States
(12) Patent Application Publication
(10) Pub. No.: US 2026/0087184 A1
(43) Pub. Date: Mar. 26, 2026

(54) Apparatus, method, machine-readable medium

(71) Applicant: Intel Corporation, Santa Clara, CA (US)

(72) Inventors: Chia Chuan WU, Bayan Lepas (MY); Vuk LESI, Cornelius, OR (US); Wei Seng YEAP, Penang (MY); Swee Aun KHOR, Bayan Lepas (MY); Marcos E. CARRANZA, Portland, OR (US)

(21) Appl. No.: 18/895,546

(22) Filed: Sep. 25, 2024

(51) Int. Cl. G06F 21/85; G06F 13/40; G06F 21/64

(52) U.S. Cl. CPC G06F 21/85; G06F 13/4081; G06F 21/64

(57) ABSTRACT

Provided is an apparatus comprising interface circuitry, machine-readable instructions, and processing circuitry to execute the machine-readable instructions to receive first data indicating that a device is plugged into an interface. The machine-readable instructions further comprise instructions to cause output of a timestamp to the device. The machine-readable instructions further comprise instructions to receive second data indicating at least an identifier relating to the device determine, based on the timestamp and the second data, a first memory mapped input/output, MMIO, offset address for the device. The machine-readable instructions further comprise instructions to receive a second MMIO offset address for the device determined by the device. The machine-readable instructions further comprise instructions to decide on integrity of the device based on a comparison of the first and the second MMIO offset addresses.

### BACKGROUND

Hot-plugging may refer to a plugging of a device into a computing system while the computing system is running. A hot-plugged device may notify the computing system of its presence based on an interface, such as a PCIe (peripheral component interconnect express) interface in which a fixed memory-mapped input output (MMIO) address is used for communication between the device and the computing system.

### BRIEF DESCRIPTION OF THE FIGURES

Some examples of apparatuses and/or methods will be described in the following by way of example only, and with reference to the accompanying figures, in which

FIG. 1 depicts a block diagram of an apparatus for deciding on integrity according to the present disclosure

FIG. 2 depicts a block diagram of an apparatus according to the present disclosure that is plugged into an apparatus, such as the apparatus of FIG. 1;

FIG. 3 depicts a flowchart of a method for an apparatus for deciding on integrity according to the present disclosure;

FIG. 4 depicts a flowchart of a method for an apparatus that is plugged into another apparatus according to the present disclosure;

FIG. 5 depicts a sequence diagram of a method for deciding on integrity and for attestation of a hot-plug device;

FIG. 6 depicts a block diagram of a computing system according to the present disclosure;

FIG. 7 depicts a block diagram of a further embodiment of a computing system according to the present disclosure in which the apparatus for deciding on integrity is based on a PCH (platform controller hub) chipset or board FPGA;

FIG. 8 depicts a platform controller hub with an embedded HDAE according to the present disclosure; and

FIG. 9 depicts a block diagram of a further embodiment of a computing system according to the present disclosure in which a PCI interposer is used.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

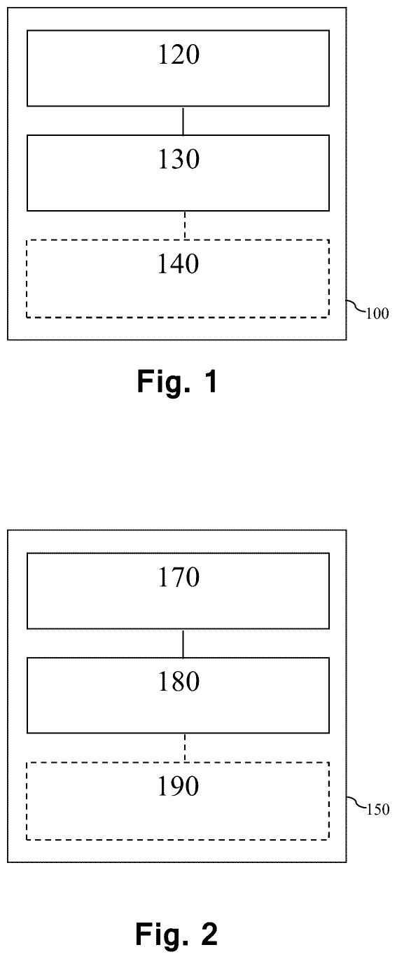

FIG. 1 illustrates a block diagram of an example of an apparatus 100 (or device 100). The apparatus 100 includes circuitry that is configured to provide the functionality of the apparatus 100. For example, the apparatus 100 of FIG. 1 includes interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The apparatus 100 may be realized as a computer, such as a server or multiple servers, a personal computer, a corporate computer, or the like.

The processing circuitry 130 is configured to receive first data indicating that a device is plugged into an interface. The interface (e.g., realized by the interface circuitry 120) may include any type of interface with which a spontaneous plugging or unplugging (e.g., hot-plugging) can be carried out, such as a USB (universal serial bus) interface, a thunderbolt interface, a PCI (peripheral component interconnect) express interface, a CXL (compute express link) interface, a SATA (serial ATA) interface, a firewire interface, an ethernet interface, a display interface (e.g., HDMI, DisplayPort, etc.), a power-supply interface, or the like.

If a device gets plugged into an interface of the apparatus, the interface circuitry 120 may detect that the device has been plugged in, e.g., if a predetermined pin of the interface has a predetermined voltage level, and notifies the processing circuitry 130 of this. However, there may be various ways in which the interface circuitry may detect that the device has been plugged in, e.g., based on a polling mechanism, or the like. In response to the detection of the device, the interface circuitry 120 may generate the first data which the processing circuitry 130 receives and which indicate that the device is plugged into the interface.

The processing circuitry 130 is further configured to cause output of a timestamp to the device (e.g., via the interface or the interface circuitry 120). A timestamp may refer to an indication of a time for synchronizing the device with the apparatus. Based on the timestamp, the apparatus and the device may generate values (MMIO offset addresses) for a which predetermined algorithm may be used, which use the timestamp. Hence, if the apparatus and the device are not synchronized, the algorithms may output different values, but as will be discussed below, for positively deciding on integrity of the device, the values may need to be the same. Therefore, the device and the apparatus may be synchronized.

The processing circuitry 130 is further configured to receive second data indicating at least an identifier relating to the device. For example, the identifier may include at least one of a device ID and a manufacturer ID. A manufacturer ID (identifier) may relate to a number or an indicator of a manufacturer that manufactured the device. A device ID may relate to a number or an indicator that the manufacturer has given the device. The identifier may be used for determining the algorithm with which the device and the apparatus determine the respective MMIO offset addresses. Additionally or alternatively, the identifier may be used for determining a private or public key for the communication between the apparatus and the device.

As indicated above, the processing circuitry 130 is further configured to determine, based on the timestamp and the second data, a first MMIO offset address for the device. MMIO offset may refer to an address offset within a memory-mapped input/output (MMIO) region of the apparatus. MMIO may allow software running on the processing circuitry 130 to interact with hardware devices (e.g., the device plugged into the interface) using memory operations. An MMIO offset may refer to a location within the MMIO region where a hardware device's register or memory is mapped. This offset is used by software (like device drivers) to address specific registers or memory areas of a device. The base address for MMIO may be defined by the operating system or firmware, and the offset may be added to this base address to calculate the final address (also referred to as actual MMIO offset address determined based on a third MMIO offset address, as discussed below) that corresponds to a specific register or control point on the hardware. For example, if a device's MMIO base address is 0x10000000, and a particular register of interest is located at an offset of 0x10 within that MMIO region. The software would access this register by reading from or writing to the address: 0x10000000+0x10=0x10000010.

According to the present disclosure, the first MMIO offset address is determined based on the second data and the timestamp. The second data (or the identifier) as well as a current time (which may be derived based on the timestamp or which may correspond to the timestamp) may be fed into a predetermined algorithm, such as a hash algorithm. A hash algorithm may be based on a cryptographic hash function (e.g., SHA (secure hash algorithm), MD5 (message digest algorithm 5), RIPEMD (RACE integrity primitives evaluation message digest), Whirpool, Blake, Tiger or non-cryptographic hash function (e.g., CRC (cyclic redundancy check), FNV (Fowler-Noll-Vo), MurmushHash, CityHash, xxHash, SipHash, Jenkins Hash, or the like). However, the present disclosure is not limited to a hash algorithm for determining the respective MMIO offset addresses.

For example, based on the identifier, an algorithm for determining the first and the second MMIO offset addresses may be determined and a key for encrypting data to be exchanged may be generated based on the identifier. Moreover, the timestamp (and in some examples also the identifier) may be fed into the algorithm which has been determined to determine the first MMIO offset address.

The device may carry out the same procedure since the device shall give the same value as generated by the apparatus in order to prove that it has not been compromised. Therefore, the processing circuitry 130 is further configured to receive a second MMIO offset address for the device determined by the device.

If the first and the second MMIO offset address are the same (or correspond in some predetermined way to each other), a first step in proving integrity of the device may be successful. Accordingly, the processing circuitry is further configured to decide on integrity of the device based on a comparison of the first and the second MMIO offset addresses.

Integrity of the device may refer to an assurance that the device that was plugged in is not compromised and that it is safe to communicate (e.g., exchange data) with the device. For example, even if the device includes safety mechanisms such as a root of trust (RoT) and hosts trusted execution environments (TEEs), it cannot be excluded that the device or the data has not been tampered with. Accordingly, the present disclosure may provide additional security for such devices which may not be connected to a larger entity all the time.

In some examples, the first data indicate a hot-plugging of the device, as indicated above. Hot-plugging may refer to an adding or removal of hardware components to or from the apparatus while the apparatus is running, without needing to power down or reboot the system. Hot-plugging may be useful in environments that require high availability and minimal downtime, such as data centers, servers, and certain consumer electronics. There may be different interfaces for hot-plugging, as already described above (e.g., PCIe, USB, thunderbolt, SATA, firewire, ethernet, display interface, power-supply interface, or the like) In some examples, the identifier includes one or more of a device identifier (or ID) and a manufacturer identifier (or ID), as discussed above. It should be noted that identifier and ID may be used synonymously herein. For example, the manufacturer ID may identify the manufacturer of the device and based on the manufacturer ID, an algorithm that the apparatus and the device use for determining the first and the second MMIO offset addresses may be determined. For example, different manufacturer may provide different capabilities in their devices, such that different algorithms may be needed or used depending on the manufacturer. The device ID may be processed together with the timestamp to determine the first and the second MMIO offset addresses. However, the present disclosure is not limited in that regard as the algorithm may always be the same and not depend on the manufacturer ID. Also, only one of the device ID and the manufacturer ID (or more IDs, such as a user ID) may be considered for determining the first and the second offset addresses.

In some examples, the second MMIO offset address is received based on a message signaled interrupt (MSI) sent by the device. An MSI may refer to a type of interrupt that uses in-band signaling over a communication bus, such as PCIe, instead of using dedicated physical interrupt lines. Thus, the MSI may be sent via a data packet to signal an interrupt over the bus system. The MSI may be generated by writing a specific value to a predefined memory address associated with an interrupt handler. If a processor detects a write to that address, it may be treated as an interrupt request.

According to the present disclosure, additional data (in addition to the interrupt request) may be sent via the MSI, i.e., at least the second MMIO offset address. In such examples, the apparatus may further include an MSI register to store the second MMIO offset address and possibly additional data sent via the MSI. In such examples, the processing circuitry 130 may be further configured to allocate the second MMIO offset address in the MSI register. For example, the additional data may include a data length value. In such examples, the processing circuitry 130 may be further configured to allocate the data length value (sent via the MSI) in the MSI register.

As indicated above, in some examples, the processing circuitry 130 is further configured to confirm integrity, if the first MMIO offset address and the second offset address correspond to each other. On the other hand, in some examples, the processing circuitry 130 is further configured to deny integrity and reject the device, if the first MMIO offset address and the second MMIO offset address do not correspond to each other.

In some examples, if integrity of the device is confirmed, the processing circuitry 130 may be further configured to determine a third MMIO offset address which is encoded by the first and the second MMIO offset address. The third MMIO offset address may correspond to an actual MMIO offset address which is only known to the apparatus and to which the device is assigned, if integrity is confirmed to communicate with the device. Thereby, a further security layer may be provided. Accordingly, in such examples, the processing circuitry 130 may be further configured to assign the device to the third MMIO offset address. For example, the apparatus (or the processing circuitry 130) may have access to a mapping table according to which a random offset (first/second MMIO offset address) is assigned to an actual offset (third MMIO offset address). The mapping table may depend on the first/second MMIO offset address, i.e., may be different for different devices and timestamps. The following mapping table is shown for illustrational purposes which depicts different assignments for two different key hashes (which will be discussed further below):

| Key Hash = 0x1653 | | Key Hash = 0x9543 | |
|---|---|---|---|
| | Actual MMIO | | Actual MMIO |
| Random Offset | Offset | Random Offset | offset |
| 0x4667 | 0x1000 | 0x3369 | 0x1000 |
| 0x9853 | 0x2000 | 0x2546 | 0x2000 |
| 0x7693 | 0x3000 | 0x7694 | 0x3000 |
| 0x3327 | 0x4000 | 0x6603 | 0x4000 |
| 0x7890 | 0x5000 | 0x7784 | 0x5000 |
| 0x1478 | 0x6000 | 0x6951 | 0x6000 |

In some examples, if integrity of the device is confirmed, the processing circuitry 130 is further configured to send a random number to the device (e.g., a NONCE (number only used once)). The random number may be used by the device to carry out an attestation (i.e., signing the random number with its private key to further prove integrity). Hence, in response to sending the random number, the processing circuitry 130 may be further configured to receive an attestation value based on the random number for verifying the device.

Attestation may be applied in a confidential computing environment (CCE), for example, to which the principles of the present disclosure may be applied to, but the present disclosure shall not be understood as limited in that regard.

Confidential computing may refer to computing, i.e., processing of data, which is carried out in a secure environment since a CCE may provide hardware-based security features, both within the processing circuitry 130 and across the broader computing system including the processing circuitry 130, to protect data in use from unauthorized access and tampering.

For example, memory encryption may be used for ensuring that the contents of the system memory (e.g., RAM) are encrypted to protect data even if physical access to the memory is obtained. Further, features such as I/O isolation secure input/output operations, preventing data leakage during transit between the processing circuitry and peripheral devices may be used.

Together, these processing circuitry and system-level features may provide a robust foundation for secure computing, ensuring that sensitive information and computations are protected throughout their lifecycle. TEEs operating on the system software may rely on the underlying system software for its initialization, execution, and management. The system software provides the necessary services and interfaces for the TEE to function securely and efficiently. A TEE may be provided within or by the processing circuitry and create isolated and secure areas for executing sensitive computations and storing confidential data. A TEE may be hosted within a CCE, such that confidential computing may be possible.

A CCE may include one or more hierarchical layered environments. Each of the one or more layered environments may be specifically designed to perform distinct computing functions within the CCE. These layers may be hierarchically structured such that a lower layer may support and attest to the integrity of a layer above it, ensuring a continuous chain of trust throughout the CCE. For example, a lower layered environment may receive a measurement from the environment layered above and sign it with its private key. The one or more layered environments may be categorized into layers based on their functions within the CCE. The layers may be logically and/or hardware-separated based on their specific functions, roles, and responsibilities within the CCE, ensuring a structured and secure computing framework. For example, there may be one or more layers designed to perform foundational security functions, such as a root of trust (RoT). The foundational security provides the essential security mechanisms and trust anchors upon which the entire framework is built. For example, the foundational security framework may comprise layers responsible for secure boot, cryptographic key management, and integrity verification. One example is the Device Identifier Composition Engine (DICE), which creates a chain of trust through layered identities and attestation. DICE may be defined in the specification “DICE Attestation Architecture” by the Trusted Computing Group, Version 1.1, Revision 0.18, Jan. 6, 2024.

In such an environment, attestation may be carried out and may refer to a mechanism that reports on protection and integrity properties of the respective TEE and also on target environments (TE), such as the RoT and layers in between (e.g., firmware layer, integrity register layer, and the like). Attestation reports may be collected at certain events, such as when the random number has to be signed by the device or when the MMIO offset value is generated.

In some examples, the processing circuitry 130 is further configured to determine the first MMIO offset address based on a predetermined hash function configured to hash the timestamp and the identifier relating to the device, as discussed above.

FIG. 2 depicts an apparatus 150 according to the present disclosure. The apparatus 150 includes interface circuitry 170, processing circuitry 180 and (optional) storage circuitry 190, which may be similar to the interface circuitry, processing circuitry and storage circuitry as already discussed under reference of FIG. 1, such that repetitive description of these components is omitted. The apparatus 150 may correspond to a device that is hot-plugged into an external device, as discussed under reference of FIG. 1. The processing circuitry 180 is configured to receive, from the external device, a timestamp in response to a hot-plugging of the apparatus into the external device, as discussed above. The processing circuitry 180 is further configured to determine a value based on timestamp and at least an identifier relating to the device using a hash function, as discussed above. For the external apparatus, the value may correspond to an MMIO offset address, as discussed above. The processing circuitry 180 is further configured to transmit, to the external device, the value.

In some examples, the processing circuitry 180 is further configured to transmit the value based on a message signaled interrupt, as discussed herein.

In some examples, the processing circuitry 180 is further configured to receive a random number from the external device in response to transmitting the value to the external device, as discussed herein. The processing circuitry 180 may be further configured to generate an attestation value based on the random number and transmit the attestation value to the external device based on a message signaled interrupt, as discussed herein.

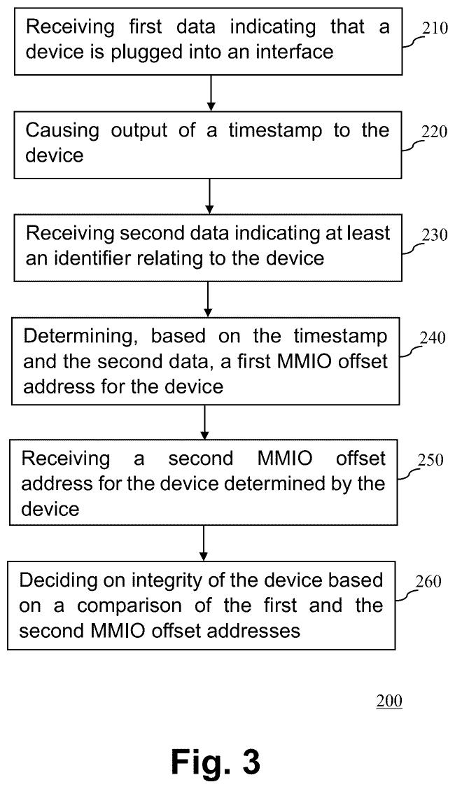

FIG. 3 depicts a flowchart of a method 200. The method 200 may be carried out by an apparatus according to the present disclosure, such as the apparatus 100 discussed under reference of FIG. 1. The method 200 includes, 210, receiving first data indicating that a device is plugged into an interface. The method 200 further includes, 220, causing output of a timestamp to the device. The method 200 further includes, 230, receiving second data indicating at least an identifier relating to the device. The method 200 further includes, 240, determining, based on the timestamp and the second data, a first MMIO offset address for the device. The method 200 further includes, 250, receiving a second MMIO offset address for the device determined by the device. The method 200 further includes, 260, deciding on integrity of the device based on a comparison of the first and the second MMIO offset addresses.

More details and aspects of the method 200 are explained in connection with the proposed technique or one or more examples described above (e.g., FIG. 1). The method 200 may comprise one or more additional optional features corresponding to one or more aspects of the proposed technique or one or more examples described above.

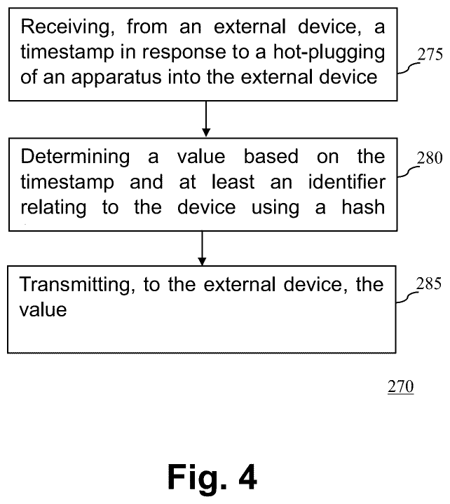

FIG. 4 depicts a flowchart of a method 270 according to the present disclosure. The method may be carried out by an apparatus according to the present disclosure, such as the apparatus 150 discussed under reference of FIG. 2. The method 270 includes receiving, 275, from an external device, a timestamp in response to a hot-plugging of an apparatus into the external device. The method 270 further includes determining, 280, a value based on the timestamp and at least an identifier relating to the device using a hash function. The method 270 further includes transmitting, 285, to the external device, the value.

More details and aspects of the method 270 are explained in connection with the proposed technique or one or more examples described above (e.g., FIG. 2). The method 270 may comprise one or more additional optional features corresponding to one or more aspects of the proposed technique or one or more examples described above.

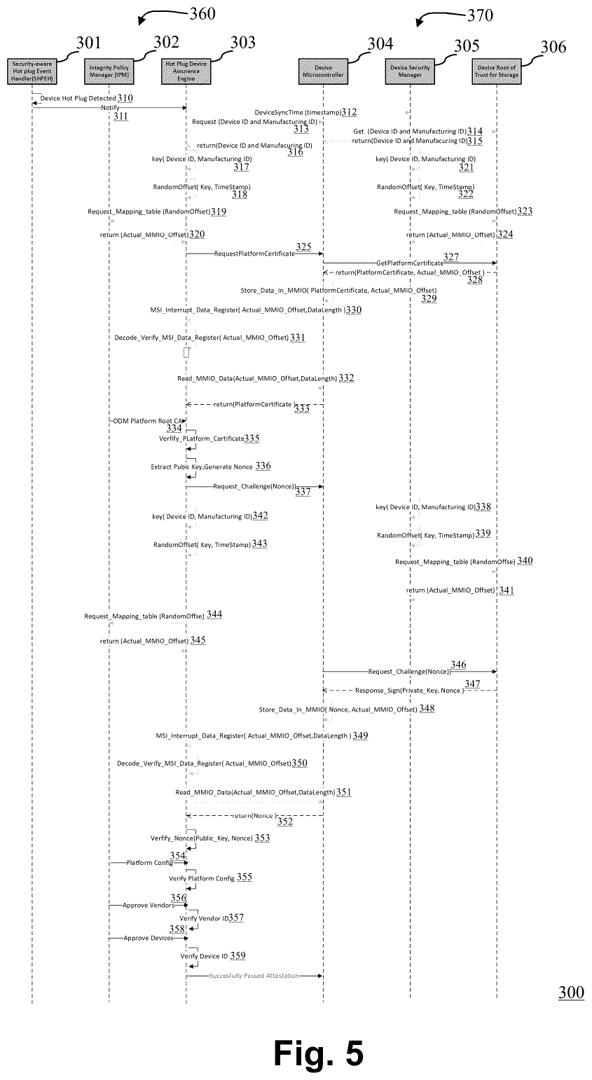

FIG. 5 depicts a sequence diagram of a method 300 according to the present disclosure. The method 300 is carried out by a first apparatus 360, which is implemented by a device which provides a confidential computing system, and a second apparatus 370, which is implemented by a hot-plug device that has been hot-plugged into the first apparatus 360. The first apparatus 360 includes, as functional elements, a security-aware hot-plug event handler (SHPEH) 301, an integrity policy manager (IPM) 302, and a hot-plug device assurance engine (HDAE) 303. The second apparatus 370 includes a device microcontroller 304, a device security manager (DSM) 305, and a device root of trust for storage 306.

Before a description of the method 300 is given, the element 301 to 306 are briefly described. The SPEH 301 is configured to receive a hot-plug interrupt signaling a new device connection and to notify the HDAE 303 to initiate an attestation process (such as the attestation process described under reference of FIG. 1 or 3 which may be started by at least one of issuing the timestamp and requesting the identifier).

The IPM 302 is configured to store a mapping table (e.g., as the table described above) for (random) number patterns to define the MMIO offset addresses for the original design manufacturer (ODM) of the hot-plug device. The IPM 302 may further store the ODM root certificate, including approved platform configurations, vendors, devices, and the like.

The HDAE 303 is configured to verify the integrity of hot-plugged devices. The HDAE 303 may be configured to apply random MMIO offset detection/generation/determination to identify rogue devices early in the attestation process.

The device microcontroller 304 is configured to include the logic to process incoming requests from the apparatus 360, respond with necessary data in the MMIO region for access. The device microcontroller 304 is configured to program the MMIO region based on the second MMIO offset address determined by the DSM 305.

The DSM 305 is configured to enforce security policies for hot-plug devices and to respond to requests from the HDAE 303 for hot-plug attestation needs. The DSM 305 is configured to retrieve the MMIO offset algorithm dynamically from the device's RoT storage 306 to calculate the second MMIO offset address.

The device RoT storage 306 is configured to securely store critical security assets tailored for hot-plug attestation use, including the random MMIO offset address algorithm, private keys, and the platform certificate. It may ensure the integrity and confidentiality of these elements, enabling secure device operations and attestation.

In the following, an exemplary sequence is given on how the respective elements 301 to 306 may interact with each other which is described in more detail afterwards under reference of the method 300.

The SPEH 301 detects new hot-plug devices (such as the second apparatus 370) through hardware pin voltage changes or a polling mechanism (or both) and notifies the HDAE 303 of the new hot-plug device.

Upon notification, the HDAE 303 enumerates the new hot-plug device, synchronizes timing, and requests a device ID and a manufacturer ID. The HDAE 303 and the DSM 305 both generate a random MMIO offset (first MMIO offset address for the HDAE 303 and second MMIO offset address for the DSM 305) for secure communication.

The device microcontroller 304 notifies the HDAE 303 that the requested information is ready by sending an MSI interrupt, embedding the second MMIO offset address within the MSI data register, as discussed above.

The HDAE 303 extracts and verifies the second MMIO offset address against its own expected value, i.e., against the first MMIO offset address. If it matches, the interaction is continued. If the offset addresses do not match, the HDAE 303 halts the attestation process and disconnects the potentially rogue hot-plug device 370.

After passing the MMIO offset verification (i.e., when the offset addresses match), the HDAE sends a challenge request based on a nonce to the hot-plug device 370. The hot-plug device 370 signs the nonce with its private key and stores it in another random MMIO offset region (that may be different since it may be generated based on the next timestamp, for example).

The hot-plug device 370 uses an MSI interrupt to notify the HDAE 303 that the challenge information is ready. The HDAE 303, upon verifying the (next) MMIO offset, raeds and verifies the signed nonce using a public key to ensure that the provided platform certificate is valid.

The IPM 302 supplies the HDAE 303 with platform configuration, approved vendors, and approved devices for verification. Once the entire attestation process is successfully completed, the HDAE 303 hands over control of the hot-plug device 370 to the operating system for device driver loading, IOMMU (Input-Output Memory Management Unit) DMA (Direct Memory Access, interrupt remapping, or the like.

In more detail, the method 300 includes, 310, detecting a hot-plug device by the SHPEH 301. The SHPEH 301 notifies, 311, the HDAE 303 of the hot-plug device.

The HDAE 303 synchronizes, 312 the apparatus 360 with the hot-plug device 370 by sending a timestamp (or timing information, in more general terms) to the DSM 305 during enumeration. Moreover, the HDAE 303 requests, 313 device ID and manufacturing ID at the device microcontroller 304. Furthermore, the HDAE 303 requests the hot-plug device's 370 base address register (BAR) for the Secure Device Manager's MMIO space, specifically BAR for the MMIO region. The IPM 302 maintains a mapping table (or logic) that correlates the device ID and manufacturing ID and timestamp combinations with randomized algorithms to map the random (first and second) offset addresses to an actual (third) MMIO offset address.

The device microcontroller 304 gets, 314, the device ID and the manufacturing ID from the device RoT for storage 306, which provides these at 315. The device microcontroller 304 returns, 316, the device ID and the manufacturing ID. The IPM 302 maintains a mapping table (or logic) that correlates the device ID and manufacturing ID and timestamp combinations with randomized algorithms to map the random (first and second) offset addresses to an actual (third) MMIO offset address.

Based on the device ID and the manufacturing ID, the HDAE 303 and the DMA 305 carry out the same (random) algorithm.

In particular, the HDAE 303 generates, 317, a key based on the device ID and the manufacturing ID, thereby ensuring that only devices with the correct IDs can generate the valid offset. In this example, the key is derived using a key derivation function (KDF), such as: Key=Hash(Devide_ID, Manufacturing_ID). For example, if the device ID is 0x1234 and the manufacturing ID is 0x5678, the key may be Hash(0x1234, 0x5678)=0x1653. The same is carried out by the DSM 305 at 321.

At 318 for the HDAE 303 and at 322 for the DSM 305, a random offset is generated. The random offset is defined, in this example, as RandomOffset=Hash(Key, Timestamp). In above example where the key is 0x1653, if the timestamp is Aug. 11, 2024, the random offset may be obtained by Hash(0x1653, “Aug. 11, 2024”)=0x4667. On the other hand, if the timestamp is Aug. 19, 2024, the random offset may be Hash(1653, “Aug. 19, 2024”)=0x9853. To ensure that the expected random MMIO offset changes over time, the algorithm uses the timestamp as input. However, the present disclosure is not limited in that regard as other means may be considered sufficient which may result in an offset that changes over time, but for which both participants obtain the same value. Since the random offset value is a hash and may not start with a 0x000 base address, a mapping table may be used, as discussed above, to map the random offset value to an actual offset value.

It should be noted that a granularity of the timestamp may depend on the circumstances. For illustrational purposes, in this example, the timestamp is the same for one day, but it can also be different each second, each microsecond, each minute, each hour, or the like. It should further be noted that the result of the hashing may depend on the hash-function that is used. The HDAE 303 further requests, 319, the mapping table for the random offset at the IPM 302 and the IPM 302 returns, 320, the actual MMIO offset based on the mapping table. For example, such a communication for the random offset 0x4667 may be illustrated as follows:

Request_Mapping_table(Random Offset = 0x4667) = Actual MMIO
Offset Return(Actual MMIO Offset) = 0x1000

A communication for the random offset 0x9853 may be illustrated as follows:

Request_Mapping_table(Random Offset = 0x9853) = Actual MMIO
Offset Return(Actual MMIO Offset) = 0x6000

Similarly, the DMA 305 requests, 323, the mapping table at the Device RoT for storage 306, and the RoT 306 returns, 324, an actual MMIO offset.

In summary, the time may need to be synchronized between the HDAE 303 and the device 370 to ensure they generate the same offset. When a device is hot-plugged in, the HDAE 303 reads the device ID and the manufacturing ID, uses these IDs to determine the appropriate algorithm, and derives the key. The HDAE 303 then generates the randomized MMIO offset using the agreed algorithm or formula and the current timestamp, as discussed herein. The device 370 generates the same randomized offset using its stored IDs and the synchronized timestamp.

The HDAE 303 requests, 325, a platform certificate at the device microcontroller 304 and the device microcontroller obtains, 327, the platform certificate at the RoT 306. Accordingly, the RoT 306 returns, 328, the platform certificate to the device microcontroller 304.

This MMIO offset is used by the device 370 to write response data into the specified MMIO range. The MMIO offset address is calculated as base address plus actual MMIO offset. For example, if the base address is 0x1000_0000 and the actual MMIO offset is 0x1000, the MMIO offset calculation may be:

$$For timestamp 1 : MMIO Address = 0 x1000\_ 0000 + 0 x0000\_ 1000 = 0 x1000\_ 1000$$

$$For timestamp 2 : MMIO Address = 0 x1000\_ 0000 + 0 x0000\_ 6000 = 0 x1000\_ 6000$$

At 329, the device microcontroller 304 stores the platform certificate under the actual MMIO offset address. When the device 370 has data ready to be read by the HDAE 303, it writes the data to the MMIO address calculated based on the random offset. Hence, at 330, the device microcontroller 304 sends an MSI, based on the actual MMIO offset address, to allocate the offset value and a data length value in a 32 bits MSI data register. A format of the register may be:

[Bits[31:16]: Randomized MMIO offset (16 bits); Bits(15:0): Data length (16 bits). For example, the following may be transmitted:

$$MMIO Offset = 0 x0000\_ 1000$$

$$MMIO Data Length = 0 x 20$$

$$MSI Data Register Value = ( Offset << 16 ) \vert Data Length$$

$$MSI Data Register Value = ( 0 x 100 << 16 ) \vert 0 x 20 = 0 x1000\_ 0000 \vert 0 x 20 = 0 x1000\_ 0020$$

At 331, the HDAE 303 decodes and verifies the MSI data transmitted at 330. The HDAE extracts the upper 16 bits to get the randomized MMIO offset and the lower 16 bits to get the data length. The HDAE 303 compares the extracted MMIO offset (second MMIO offset address) from the MSI data with the expected offset (first MMIO offset address).

If the offsets match, the HDAE 303 proceeds to read, 332 the data from the MMIO address (base address plus randomized offset) with the specified length. If the offsets do not match, the HDAE 303 identifies the device 370 as potentially rogue, stops the links, and takes an appropriate action (e.g., rejects the device).

Assuming the offsets match, the device microcontroller 304 returns, 333, the platform certificate to the HDAE 303. Moreover, the HDAE 303 receives, 334, from the IPM 302, an ODM platform root certificate. Based on the ODM platform root certificate, the HDAE 303 verifies, 335, the platform certificate, extracts, 336, a public key and generates a nonce. Based on the nonce, the HDAE 303 sends, 337, to the device microcontroller 304 a request challenge.

Upon receiving the challenge, the DSM 305 generates, 338, a key based on the device ID and manufacturing ID, generates, 339, a random offset based on the key and the timestamp, requests, 340, a mapping table based on the random offset, which is returned, 341, by the RoT 306, as already discussed above. The process is carried out again since, in this example, the timestamp is different than before. Therefore, the determined random offset is different than before, such that data is written in a different MMIO region. Hence, it may be more challenging for an attacker to predict the location of the data since it changes with each timestamp. A similar process is carried out by the HDAE 303, i.e., the HDAE 303 generates, 342, a key, generates, 343, a random offset, requests, 344, a mapping table, which is returned, 345, by the IPM 302.

Moreover, the device microcontroller 304 forwards, 346, the request challenge to the RoT 346. The RoT 306 signs, 347 the nonce with its private key and transmits it to the device microcontroller 304. The device microcontroller 304 stores, 348, the signed nonce and writes it, 349, based on an MSI to the MMIO register, using the determined actual MMIO offset determined at 341.

Upon reception of the MSI, the HDAE 303 decodes and verifies, 350, the MSI data register. At 351, the HDAE 303 reads the MMIO data from the device microcontroller 304 and obtains, 352, the signed nonce, which it verifies at 353. Upon verifying the nonce, the IPM 302 provides, 354, the platform configuration, which is verified, 355, by the HDAE 303. Moreover, the IPM 302 provides, 356, a vendor ID, which is verified, 357, by the HDAE 303. Moreover, the IPM 302 provides, 358, a device ID, which is verified, 359, by the HDAE 303.

If every verification step was successful, the attestation is successfully passed, which the HDAE 303 transmits to the device microcontroller 304, such that data exchange can be carried out.

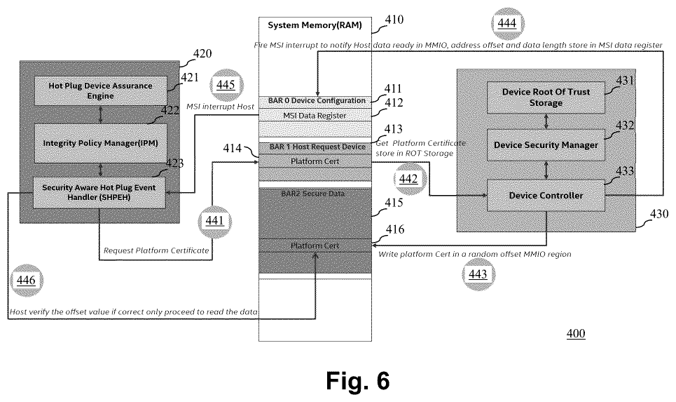

FIG. 6 depicts a system 400 including system memory (RAM), a first apparatus 420, and a second apparatus 430. The first apparatus 420 is similar to the first apparatus 360 of FIG. 5, such that repetitive description of the elements is omitted. Also, the second apparatus 430 is similar to the second apparatus 470 of FIG. 5, such that repetitive description of the elements is omitted. Accordingly, the first apparatus 420 includes an HPAE 421, an IPM 422, and a SHPEH 423. The second apparatus 430 includes a RoT 431, DSM 432, and a device microcontroller 434. The RAM 410 includes a BAR0 (Device Configuration) 411 in which an MSI data register region 412 is provided. The RAM 410 further includes a BAR1 (Host Request Device) including a platform certificate region 414. The RAM 410 further includes BAR2 (Secure Data) including a platform certificate region 416.

In response to a hot-plug event, the SHPEH 423 is configured to request, 441, the platform certificate at BAR1. The RAM 410 obtains, 442, the platform certificate from the device controller 433 which writes, 443, the platform certificate in the platform certificate region 416, i.e., in an isolated memory region (i.e., secure isolation may be provided according to the present disclosure). Moreover, the device controller 433 is configured to fire, 444, to BAR0 411, an MSI to notify the host that data is ready in the MMIO. The MSI includes the MSI offset address and a data length stored in the MSI data register region 412, as discussed herein. The RAM 410 is configured to forward, 445, the MSI to the first apparatus 420. The SHPEH 423 is configured to verify, 446, the offset value received from the second apparatus 430 and, if the offset value is correct, to read the data from the second apparatus 430.

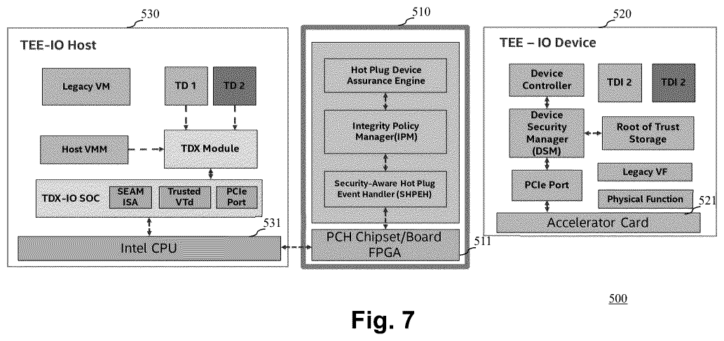

FIG. 7 depicts a system 500 including a first apparatus 510 for deciding on integrity of a second apparatus (hot-plug device or TEE-IO device) 520. The system 500 further includes the second apparatus 520 and a computing system (or TEE-IO host) 530. The system 500 relies on Intel TDX as the TEE-IO host 530 and utilizes a PCIe-based hot-plug-enabled accelerator card 521. The HPAE is implemented using software logic only, hardware logic only, or a combination of both in a digital trusted controller. However, in the present example, the first apparatus 510 includes at least one trusted CPU, trusted memory storage, and trusted persistent storage for firmware. The first apparatus 510 is positioned between the host 530 and the device 520. The HDAE is embedded in a PCH controller or board FPGA 511 which communicates with a CPU 531 of the host 530. For example, the HDAE is based on at least one of software and hardware logic located between a host SoC (system on chip) and the device. The remaining elements of the first apparatus 510 (HDAR, IPM, SHPEH) have already been discussed previously and a repetitive description thereof is omitted. The second apparatus 520 includes a device microcontroller a DSM and an RoT, as already previously discussed, such that a repetitive description of these elements is also omitted. The second apparatus 520 further includes components for providing a PCIe interface including a PCIe port, a legacy virtual function (VF), a physical function, a transport driver interface (TDI), and the accelerator card 521. The host 530 further includes other TDX components for processing, such as a TDX-IO SOC, a TDX module, transport drivers (TD), a host virtual machine management software, and a legacy virtual machine.

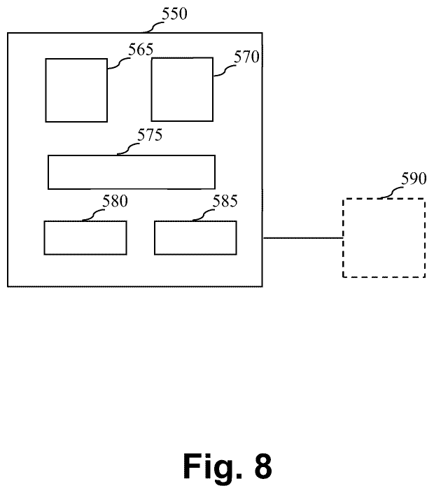

FIG. 8 depicts a PCH 550 (as discussed under reference of FIG. 7) in more detail. The PCH 550 is configured to communicate with a PCI (not depicted) and with a PCIe device 580. The PCH 550 includes a display 565, an IME (Intel management engine) 570, an input/output controller 575, a real-time clock 580m and an HDAE 585 (as previously discussed).

On the other hand, if the PCH is implemented based on a board FPGA, as depicted in FIG. 7, the FPGA may be located between a PCIe slot and an SoC, such that the HDAE is used for hot-plug attestation.

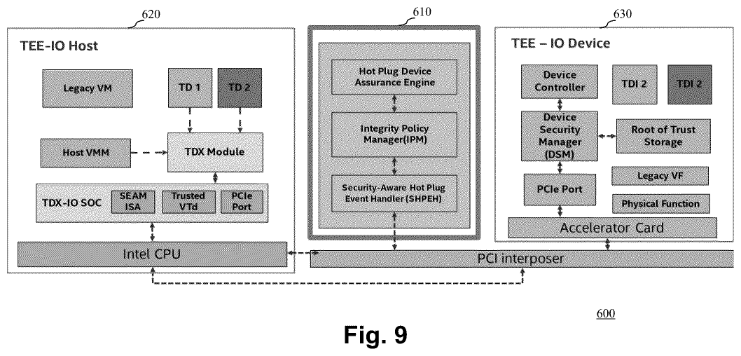

FIG. 9 depicts a system 600 which is similar to the system 500, but instead of the PCH chipset/board FPGA, the system 600 utilizes a PCI interposer between the device 630 and the host 620, such that the PCI interposer is configured to communicate with the accelerator card, the SHPEH and the host CPU. The PCI interposer (or PCIe interposer) may be used to probe PCIe bus signals into a logic analyzer for providing the HDAE, but the present disclosure is not limited in that regard since the interposer may include a microcontroller or compute logic to host the HDAE.

According to the present disclosure, the following effects may be achieved. It should be noted that the effects are enlisted in no particular order and that more effects may be achieved and the present disclosure is not limited to the mentioned effects in any way:

1. Early Detection: A host (or a first apparatus) can detect a rogue device at the very beginning after the hot-plug event by verifying if the device outputs the expected random MMIO offset address before even reading any data from the hot-plug device.

2. Simplified Process: Embedding both the offset and data length in the MSI data may simplify the host's process, as it receives all necessary information in one interrupt.

3. Efficiency: This approach may be efficient because the host may quickly decode the MSI data, verify the integrity of the device, and proceed with the data read if everything checks out.

4. Instant Feedback: The system may instantly determine whether a device is legitimate based on the MSI data, providing faster response times compared to waiting for a full attestation process. This immediate feedback may allow for quicker decision-making and may reduce the window of opportunity for an attacker.

5. Prevention of Deeper Intrusion: By cutting off communication at the first sign of irregular MSI data, the system may prevent a rogue device from gaining deeper access or executing more complex attacks.

6. Interrupt Validation: Rogue devices might attempt to overwhelm the system by generating a high volume of interrupts. However, by validating the random MMIO pattern within the interrupt data, the system may detect and block such devices before they cause significant damage.

7. Reduced Load on Attestation Process: Traditional attestation may involve multiple steps and can be time-consuming, especially when handling many hot-plugged devices. By using MSI data for early validation, the system can eliminate rogue devices before the full attestation process.

8. Immediate Notification: MSIs may provide a mechanism for the device to asynchronously notify the host that data is ready. This may avoid the need for the host to constantly poll the device or MMIO space, reducing CPU overhead and latency.

9. Enhanced Security Through Address Randomization: In contrast to using a static address, by providing a random MMIO address each time (an MMIO address that changes), the device may obfuscate the location of sensitive data. This may make it more difficult for an attacker to predict or target the data location.

10. The present disclosure may enable to use hot-plug device capabilities without paying the penalty in reduced security guarantees, while enhancing serviceability and availability. Hence, the present disclosure may provide a way to ensure platform integrity assurance for hot-plug devices.

11. The bar for Man-in-the-Middle, Rogue Device, and Device Masquerade attacks may be raised. By not relying on third-party OS/VMM, kernel, or user-space components, the disclosure may complement existing technologies such as Virtualization Technology for Directed I/O (VT-d) and Trust Domain Extensions (TDX).

12. The principles of the present disclosure may be agnostic to an operating system and/or virtual machine management (VMM) software. Security may be achieved by dynamic re-establishment of the hardware chain of trust without the need for a platform reboot.

In the following, some examples of the proposed technique are presented: An example (e.g., example 1) relates to an apparatus including interface circuitry, machine-readable instructions, and processing circuitry to execute the machine-readable instructions to receive first data indicating that a device is plugged into an interface. The machine-readable instructions further include instructions to cause output of a timestamp to the device. The machine-readable instructions further include instructions to receive second data indicating at least an identifier relating to the device. The machine-readable instructions further include instructions to determine, based on the timestamp and the second data, a first memory mapped input/output, MMIO, offset address for the device. The machine-readable instructions further include instructions to receive a second MMIO offset address for the device determined by the device. The machine-readable instructions further include instructions to decide on integrity of the device based on a comparison of the first and the second MMIO offset addresses.

Another example (e.g., example 2) relates to a previous example (e.g., example 1) or to any other example, wherein the first data indicate a hot-plugging of the device.

Another example (e.g., example 3) relates to a previous example (e.g., example 1 or 2) or to any other example, wherein the identifier includes one or more of a device identifier and a manufacturer identifier.

Another example (e.g., example 4) relates to a previous example (e.g., any one of examples 1 to 3) or to any other example, wherein the second MMIO offset address is received based on a message signaled interrupt, MSI, sent by the device. In such examples, the machine-readable instructions further include instructions to allocate the second MMIO offset address in an MSI register. The machine-readable instructions include instructions to allocate a data length value, sent via the MSI, in the MSI register.

Another example (e.g., example 5) relates to a previous example (e.g., any one of examples 1 to 4), wherein the machine-readable instructions further include instructions to deny integrity and reject the device, if the first MMIO offset address and the second MMIO offset address do not correspond to each other.

Another example (e.g., example 6) relates to a previous example (e.g., any one of examples 1 to 5), wherein the machine-readable instructions further include instructions to confirm integrity of the device, if the first MMIO offset address and the second MMIO offset address correspond to each other.

Another example (e.g., example 7) relates to a previous example (e.g., example 6) or to any other example, wherein, if integrity of the device is confirmed, the machine-readable instructions further include instructions to determine a third MMIO offset address which is encoded by the first and the second MMIO offset address. In such examples, the machine-readable instructions further include instructions to assign the device to the third MMIO offset address.

Another example (e.g., example 8) relates to a previous example (e.g., any one of examples 1 to 7), wherein, if integrity of the device is confirmed, the machine-readable instructions further include instructions to send a random number to the device and receive an attestation value based on the random number for verifying the device.

Another example (e.g., example 9) relates to a previous example (e.g., any one of examples 1 to 8), wherein the machine-readable instructions further include instruction to determine the first MMIO offset address based on a predetermined hash function configured to hash the timestamp and the identifier relating to the device.

An example (e.g., example 10) relates to an apparatus including interface circuitry, machine-readable instructions, and processing circuitry to execute the machine-readable instructions to receive, from an external device, a timestamp in response to a hot-plugging of the apparatus into the external device. The machine-readable instruction further include instructions to determine a value based on timestamp and at least an identifier relating to the device using a hash function. The machine-readable instructions further include instructions to transmit, to the external device, the value.

Another example (e.g., example 11) relates to a previous example (e.g., example 10) or to any other example, wherein the machine-readable instructions further include instructions to transmit the value based on a message signaled interrupt.

Another example (e.g., example 12) relates to a previous example (e.g., example 10 or 11) or to any other example, wherein the machine-readable instructions further include instructions to receive a random number from the external device in response to transmitting the value to the external device. The machine-readable instructions further include instructions to generate an attestation value based on the random number. The machine-readable instructions further include instructions to transmit the attestation value to the external device based on a message signaled interrupt.

An example (e.g., example 13) relates to a method including receiving first data indicating that a device is plugged into an interface. The method further includes causing output of a timestamp to the device. The method further includes receiving second data indicating at least an identifier relating to the device. The method further includes determining, based on the timestamp and the second data, a first memory mapped input/output, MMIO, offset address for the device. The method further includes receiving a second MMIO offset address for the device determined by the device. The method further includes deciding on integrity of the device based on a comparison of the first and the second MMIO offset addresses.

Another example (e.g., example 14) relates to a previous example (e.g., example 13) or to any other example, wherein the method further includes confirming integrity of the device, if the first MMIO offset address and the second MMIO offset address correspond to each other.

Another example (e.g., example 15) relates to a previous example (e.g., example 14) or to any other example, wherein, if integrity of the device is confirmed, the method further includes determining a third MMIO offset address which is encoded by the first and the second MMIO offset address and assigning the device to the third MMIO offset address.

Another example (e.g., example 16) relates to a previous example (e.g., any one of examples 13 to 15) or to any other example, wherein, if integrity of the device is confirmed, the method further includes sending a random number to the device and receiving an attestation value based on the random number for verifying the device.

Another example (e.g., example 17) relates to a previous example (e.g., any one of examples 13 to 16) or to any other example, wherein the method further includes determining the first MMIO offset address based on a predetermined hash function configured to hash the timestamp and the identifier relating to the device.

An example (e.g., example 18) relates to a method including receiving, from an external device, a timestamp in response to a hot-plugging of an apparatus into the external device. The method further includes determining a value based on timestamp and at least an identifier relating to the device using a hash function. The method further includes transmitting, to the external device, the value.

Another example (e.g., example 19) relates to a previous example (e.g., example 18), wherein the method further includes transmitting the value based on a message signaled interrupt.

Another example (e.g., example 20) relates to a previous example (e.g., example 18 or 19), wherein the method further includes receiving a random number from the external device in response to transmitting the value to the external device. The method further includes generating an attestation value based on the random number. The method further includes transmitting the attestation value to the external device based on a message signaled interrupt.

An example (e.g., example 21) relates to a machine-readable medium including machine readable instructions, when executed, to implement a method according to any one of examples 13 to 20 or according to any other example or to realize an apparatus according to any one of examples 1 to 12 or according to any other example.

An example (e.g., example 22) relates to an apparatus including processor circuitry configured to carry out a method according to a previous example (e.g., any one of examples 13 to 20) or to any other example.

Another example (e.g., example 23) relates to a computer program having a program code for performing the method of a previous example (e.g., any one of examples 13 to 20) or to any other example, when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processing circuitry to execute the machine-readable instructions to:
receive first data indicating that a device is plugged into an interface;
cause output of a timestamp to the device;
receive second data indicating at least an identifier relating to the device;
determine, based on the timestamp and the second data, a first memory mapped input/output, MMIO, offset address for the device;
receive a second MMIO offset address for the device determined by the device; and
decide on integrity of the device based on a comparison of the first and the second MMIO offset addresses.

2. The apparatus of claim 1, wherein the first data indicate a hot-plugging of the device.

3. The apparatus of claim 1, wherein the identifier includes one or more of a device identifier and a manufacturer identifier.

4. The apparatus of claim 1, wherein the second MMIO offset address is received based on a message signaled interrupt, MSI, sent by the device, and wherein the machine-readable instruction further comprise instructions to:
allocate the second MMIO offset address in an MSI register; and
allocate a data length value, sent via the MSI, in the MSI register.

5. The apparatus of claim 1, wherein the machine-readable instructions further comprise instructions to:
deny integrity and reject the device, if the first MMIO offset address and the second MMIO offset address do not correspond to each other.

6. The apparatus of claim 1, wherein the machine-readable instructions further comprise instructions to:
confirm integrity of the device, if the first MMIO offset address and the second MMIO offset address correspond to each other.

7. The apparatus of claim 6, wherein, if integrity of the device is confirmed, the machine-readable instructions further comprise instructions to:
determine a third MMIO offset address which is encoded by the first and the second MMIO offset address; and
assign the device to the third MMIO offset address.

8. The apparatus of claim 1, wherein, if integrity of the device is confirmed, the machine-readable instructions further comprise instructions to:
send a random number to the device; and
receive an attestation value based on the random number for verifying the device.

9. The apparatus of claim 1, wherein the machine-readable instructions further comprise instruction to:
determine the first MMIO offset address based on a predetermined hash function configured to hash the timestamp and the identifier relating to the device.

10. An apparatus comprising interface circuitry, machine-readable instructions, and processing circuitry to execute the machine-readable instructions to:
receive, from an external device, a timestamp in response to a hot-plugging of the apparatus into the external device;
determine a value based on timestamp and at least an identifier relating to the device using a hash function;
transmit, to the external device, the value.

11. The apparatus of claim 10, wherein the machine-readable instructions further comprise instructions to:
transmit the value based on a message signaled interrupt.

12. The apparatus of claim 10, wherein the machine-readable instructions further comprise instructions to:
receive a random number from the external device in response to transmitting the value to the external device;
generate an attestation value based on the random number; and
transmit the attestation value to the external device based on a message signaled interrupt.

13. A method comprising
receiving first data indicating that a device is plugged into an interface;
causing output of a timestamp to the device;
receiving second data indicating at least an identifier relating to the device;
determining, based on the timestamp and the second data, a first memory mapped input/output, MMIO, offset address for the device;
receiving a second MMIO offset address for the device determined by the device; and
deciding on integrity of the device based on a comparison of the first and the second MMIO offset addresses.

14. The method of claim 13, further comprising
confirming integrity of the device, if the first MMIO offset address and the second MMIO offset address correspond to each other.

15. The method of claim 14, wherein, if integrity of the device is confirmed, the method further comprises:
determining a third MMIO offset address which is encoded by the first and the second MMIO offset address; and
assigning the device to the third MMIO offset address.

16. The method of claim 13, wherein, if integrity of the device is confirmed, the method further comprises:
sending a random number to the device; and
receiving an attestation value based on the random number for verifying the device.

17. The method of claim 13, further comprising:
determining the first MMIO offset address based on a predetermined hash function configured to hash the timestamp and the identifier relating to the device.

18. The method of claim 13, wherein the second MMIO offset address is received based on a message signaled interrupt, MSI, sent by the device, the method further comprising:
allocating the second MMIO offset address in an MSI register; and
allocating a data length value, sent via the MSI, in the MSI register.

19. The method of claim 13, further comprising:
denying integrity and rejecting the device, if the first MMIO offset address and the second MMIO offset address do not correspond to each other.

20. The method of claim 13, wherein the first data indicate a hot-plugging of the device.
